(19) United States
(12) Patent Application Publication
(10) Pub. No.: US 2014/0074679 A1
(43) Pub. Date: Mar. 13, 2014

(54) TARGETED OBJECTIVE COMPLEMENTARY CURRENCY

(71) Applicants: Bart P.E. van Coppenolle, Leuven (BE); Philip W.J. Vandormael, Leuven (BE)

(72) Inventors: Bart P.E. van Coppenolle, Leuven (BE); Philip W.J. Vandormael, Leuven (BE)

(21) Appl. No.: 14/013,505

(22) Filed: Aug. 29, 2013

Related U.S. Application Data
(63) Continuation-in-part of application No. 13/525,942, filed on Jun. 18, 2012.
(60) Provisional application No. 61/694,551, filed on Aug. 29, 2012.

(51) Int. Cl. G06Q 40/00

(52) U.S. Cl. CPC G06Q 40/00
USPC 705/35

(57) ABSTRACT

A financial instrument includes a token representation of a complementary currency associated with the primary currency, whose value amount is substantiated and secured by an asset base having intrinsic value, and enables at least a portion of the value of the primary currency to be payable upon redemption or exchange to at least one of a social, environmental or non-secular recipient or cause, as defined by a holder of the financial instrument.

### CROSS-REFERENCE TO RELATED APPLICATIONS

This application claims priority to the following co-pending U.S. patent applications, the subject matters of which are incorporated herein by this reference for all purposes, including the following:

U.S. Provisional Patent Application Ser. No. 61/694,551, filed on Aug. 29, 2012, entitled TARGETED OBJECTIVE COMPLEMENTARY CURRENCY, attorney docket number 44785.00109 PROV;

U.S. patent application Ser. No. 13/525,942, filed on Jun. 18, 2012, entitled VALUE BANKING SYSTEM AND TECHNIQUE UTILIZING COMPLEMENTARY VALUE CURRENCY, attorney docket number 44785.00100 of which this application is also a continuation-in-part thereof.

### FIELD OF THE INVENTION

The disclosure relates to banking systems, and, more specifically, to a free-market currency in which the value of money is defined by the holder, and to one or more complementary currencies having corresponding socially responsible objectives.

### BACKGROUND OF THE INVENTION

The current state of the art in monetary systems is fiat money with fractional reserve. The objective value of such currency is fixed by law, hence it is referred to as fiat money. Only a fraction of the intrinsic objective value of fiat money is determined by gold, the remainder is backed by government and private debt and other assets, typically not having an objective intrinsic value, causing the subjective market value of the current fiat money to fluctuate volatilely and inconsistently within different branches of the economy. This is a root cause of monetary instability conditions such as inflation and deflation or disinflation, causing economic crises.

Complementary currencies to existing fiat money also exist, however, such complementary currencies do not secure economic value over time and therefore risk losing value, constituting their main objective disadvantage. Such complementary currencies, however, each serve their own specific social or environmental goal, being their main subjective advantage. The subjective value that such complementary currency supports may be not economical, but moral, such as in the value ‘caregiving’ or ‘rainforest protection’. However, since such complementary currencies do not securely store value, they are not trusted for storing capital. Therefore social or environmental causes are currently supported primarily by government action or charity. However, government funding decreases when government funding is at risk and only fully capitalized entities contribute substantially to charity, creating the main drawback to the current wealth sharing system. If saving i.e. securely storing value over time could be done while supporting moral values, more funds would flow towards such moral values.

Accordingly, a need exists for one or more socially responsible complementary currencies that enable securely storing value over time while supporting socially responsible or moral objectives.

### SUMMARY OF THE DISCLOSURE

Subjective values are first subjective moral ideas, such as gratitude for economic value, before they become objective categories. Economic objective value is only one dimension of moral value; other dimensions are e.g. social value and environmental or religious value. Value then comes in different flavors or colors, so too, as proposed herein, are different types of complementary currency associated with value money, each with a different socially responsible objectives and characterized by different color and/or look and feel.

Value Money, that is money that is substantiated by, backed by or that represents value equity stock as described herein, is referred to herein as Blue Money. Blue Money has objective, intrinsic and stable economic value.

In order to protect the various complementary money types proposed herein from losing value, because of monetary effects such as inflation in the dominant fiat currency or because of an ineffective structural set-up, these complementary currencies are coupled to Value Money, thereby being value secured and trustworthy for saving purposes. The structure of such coupling and effective set-up and the practical implementation is described herein. Currency that securely stores and therefore supports economic value is referred to herein as Value Money or Blue Money. Currency that supports social value and is coupled with Blue Money as well as properly set-up is referred to herein as Red Money. Currency that supports an environmental or nonsecular value and is coupled with Blue Money as well as properly set-up is referred to herein as Green Money.

By implementing and using money in three dimensions: economic (blue), social (red) and environmental or nonsecular (green), people are able to save their created value, while contributing to their social or moral value of choice. Spending tax money on these values can therefore be reduced, while private spending takes over, freeing up government budgets to reduce debt and solve the current financial and sovereign debt crises.

According to the disclosure, a financial instrument includes a token representation of a complementary currency associated with the primary currency, whose value amount is substantiated and secured by an asset base having intrinsic value, and enables at least a portion of the value of the primary currency to be payable upon redemption or exchange to at least one of a social, environmental or non-secular recipient or cause, as defined by a holder of the financial instrument.

According to one aspect of the disclosure, an article of manufacture for use as a complementary currency to a primary value currency comprises: A) a token representation of an amount of value as an amount of complementary currency; B) a mechanism integrated with the token representation for substantiating a value of the primary currency with an underlying asset having intrinsic value associated with the amount of complementary currency; and C) a mechanism for identifying that a portion of the value of the complementary currency is designated for at least one of a predetermined recipient and cause. In other embodiments, the complementary currency specifically identifies portions of its value intended for recipients selected from any of social, environmental or religious objectives.

According to another aspect of the disclosure, a financial instrument comprises: A) a token representation of a primary currency having a value amount substantiated and secured by an asset base having intrinsic value and associated with the value amount of the primary currency; B) a token representation of a complementary currency associated with the primary currency; and wherein the complementary currency defines at least a portion of the value of the primary currency payable to at least one of a social, environmental or non-secular recipient or cause, as defined by a holder of the financial instrument.

According to yet another aspect of the disclosure, a method of preventing fluctuations in the value of a tangible currency or an intangible token of such tangible currency or an intangible currency, the method comprises: A) providing an amount of a tangible currency or of an intangible token of such tangible currency or of an intangible currency, as a tangible or intangible token representing an amount of value, the amount of currency having a numerical nominative value; B) substantiating the intrinsic value of the amount of currency with a portfolio of equity instruments by making the amount of currency a certificate representing ownership or profit rights in the portfolio of equity instruments; and C) directing at least a portion of the value of the currency payable to at least one of a social, environmental or nonsecular recipient or cause, as defined by a holder of the financial instrument. In one embodiment, the proceeds of the complementary currency are directed may include one or more social goals including, but are not limited to socially conscious targeted objectives such as: care for elderly, child care, care for specific illnesses, general disease caring, homeless caring, education, etc. In another embodiment, the defined assets to which the proceeds of the complementary currency are directed may include one or more environmental or religious/nonsecular objectives including, but are not limited to buying rain forest assets, buying ocean assets, buying fishing quotas, buying CO2 certificates, buying or building churches, etc.

According to yet another aspect of the disclosure, a computerized banking system comprises: A) at least one network accessible central bank system comprising: i) a network interface; ii) at least one processor; iii) a memory for storing an executable equity portfolio model and a plurality of predefined rules associated with selection or trading of equity instruments and the issuance of currency, the currency; B) at least one certificate, the certificate representing ownership or profit rights in the portfolio of equity instruments and having associated therewith an amount of value currency substantiated by intrinsic value of a portion of the portfolio of equity instruments; and C) a data structure associated with each certificate and stored in memory, the data structure comprising: i) data identifying the certificate; ii) data identifying an owner of the certificate; iii) data identifying at least one of a social, environmental or non-secular recipient or cause; iv) data identifying a percentage of the value currency of the certificate to which the identified social, environmental or non-secular recipient or cause is entitled.

### DESCRIPTION OF THE DRAWINGS

FIG. 1A illustrates conceptually the relationship between physical goods and/or intangible services, the new complementary value currency described herein and the equity portfolio substantiating such new complementary currency:

FIG. 18 illustrates conceptually the relationship between physical goods and/or intangible services, the targeted objective complementary currency described herein, the value currency and equity portfolio substantiating such value currency;

FIG. 2 illustrates conceptually a network environment in which the Value Banking System disclosed herein may be implemented;

FIG. 3 illustrates conceptually system architecture, respectively in which the system disclosed herein may be implemented;

FIGS. 4A-B illustrates conceptually data structures useful in implementing the new complementary currency and free-market banking system in accordance with the disclosure;

FIGS. 5A-C illustrate conceptually the relationship between complementary currency and assets having an objective value in accordance with the disclosure;

FIGS. 6A-C illustrate a conceptual diagram of the transactional flow between money and public value stock as well as loans and savings bonds according to the disclosure;

FIG. 7 is a conceptual diagram illustrating the transactional flow between Money and Value of the Value Banking System's Central Value Bank's balance structure according to the disclosure;

FIG. 8 illustrates conceptually a flow diagram of a Safety Margin algorithm in which the Value Stock selection by the Central Value Bank in the Value Banking System disclosed herein may be implemented; and

FIG. 9 illustrates conceptually a flow diagram illustrating the process for creating an redeeming the value of a targeted objective complementary currency in accordance with the disclosure; and

FIG. 10 illustrates conceptually a data structure useful in implementing targeted objective complementary currency in accordance with the disclosure.

### DETAILED DESCRIPTION

Selected terms and phrases as used herein have the following meanings:

Financial Crisis—A crisis caused by the financial system or the bank system, such as a recession or depression. The Great Depression of the last century's thirties, as well as the current financial crisis are constitutive or inductive examples that formed the concept of a Financial Crisis.

Monetary Confusion—The confusion between the variation of the Value of a good and the variation of the Value of Money used to express the Value of the good, as its price.

Free-Market Banking System—A Free-Market Banking System is a banking system in which interests on savings and loans are freely determined by the market without government intervention and where Money can freely compete to become the (most popular, or most current) Currency.

Money and Currency—Money is a means of storing and exchanging value, enabling barter trades within a community to be executed in the absence of the actual goods involved in the barter. Money that is actively and fluently used in a community becomes a Currency. Money is individually used by humans to store Value over time and collaboratively by a community, as a Currency, to exchange Value.

Value Certificate Value—Certificates consist of electronic, paper, metal or other tokens of the right to value, typically the right to participate in the partial or full liquidation of assets held on the active side of a balance sheet, where the passive of that balance sheet consists of those Value Certificates.

Certificate Money—Certificate Money consists of Value Certificates that are individually used as Money to store Value over time and collaboratively by a community, as Currency, to exchange Value.

Value Banking System—A Value Banking System is a banking system in which the Money consists of Value Certificates backed by Value Stock.

Value Stock—Value Stock is equity stock in an enterprise (en entrepreneurial activity with the aim to create Value) that has maximal Safety Margin between Objective Intrinsic Value and Subjective Market Price.

Metal Money—Metal Money is made of metal. The metal can be the actual valuable asset providing Value to Money or just be a token of it, as Certificate Money.

Physical Gold Money—Non-Certificate Metal Money, where the metal is gold.

Gold Certificate Money—Certificate Money where gold is the asset on the active side of the balance sheet, of which the Value Certificates represent the passive.

Complementary Currency—A Complementary Currency consists of Certificate Money that is freely used by a community or a subdivision of a community, as a currency that runs in parallel to the existing Legal Tender Currency.

Legal Tender Currency or Fiat Money—The Legal Tender Currency is the dominant currency of a jurisdiction that is imposed by legal tender law. The legal tender law fixes the Nominal Value of Fiat Money, having caused it in history to be the Currency of the community dominated by that jurisdiction.

Nominal Value—The Nominal Value of Certificate Money is the Objective Value determined by the name (in words) and the amount (in numbers) displayed on Certificate Money. The name and number can also be united in one figure, as the face of the issuer (or someone else the issuer chose).

Complementary Value Currency—A Complementary Value Currency is a Complementary. Currency that consists of Value Money.

Value Money or Currency—Value Money or a Value Currency consists of Certificate Money that is a token of participation in assets with Intrinsic Value that are acquired with application of a Safety Margin.

Intrinsic Value—Intrinsic Value of an Object is the Objective Value of that Object that is logically derived as a necessary characteristic of that language Object, resulting from the definition of that Object and a formally and logically correct deductive reasoning.

Safety Margin—A Safety Margin is the margin of safety that exists between the higher Objective Intrinsic Value of a Good and the lower Subjective Market Price at which that Good is acquired.

Object—An Object is a mental projection emerging from networked neuronal firing that is logically and/or numerically consistently interpretable by a different Subject than the Subject that expressed it in language and/or numbers. Most mental projections are not entirely Objective. People tend to believe or assume that there remains a residual non-consistency between mental projections in different Subjects. The Object is therefore a reduction of the mental projection, caned notion, concept or idea.

Left Brain Consciousness—The Left Brain Consciousness is the consciousness that emerges from the entire brain, under the direction of the left pre-frontal cortex. Since Language is (in the vast majority of human brains) directed from the same left pre-frontal cortex, Left Brain Consciousness is also defined as language consciousness or Objective consciousness. In language consciousness, the law of non-contradiction is tautologically valid, creating a one dimensional consciousness between positively affirming a language statement and negating it, expressed in the logical formulation of the law of non-contradiction as (+p)+(−p)=0.

Subject—A Subject is a mental projection that is not (yet) entirely logically and/or numerically reducible in Objects, without residual non-consistency or Bivalence. A raw or total Subject contains conscious as well as sub- or pre-conscious information on phenomena and therefore also includes all known Objective dimensions. A pure or remaining Subject contains only the residual non-consistency that hasn't yet been logically and/or numerically consistently interpreted in objects. Human beings, as well as animals, are classical constitutive or inductive examples that formed the concept of a Subject, also referred to as a spirit or psyche. The word Subject not only means a human or other living being, it means also the Subject of a sentence, as well as the Subject as the topic of a writings or conversations, as in the Subject or topic of a scientific discipline, meaning the total field of knowledge of certain phenomena.

Right Brain Consciousness—The Right Brain Consciousness is the consciousness that emerges from the entire brain, under the direction of the right pre-frontal cortex. The Right Brain Consciousness empathically integrates phenomena into images and Subjects, to induce concepts, invent ideas or intuitively visualize meaning as a notion. While the Left Brain Consciousness is analytically reducing and differentiating phenomena from all over the brain into Objects, the Right Brain Consciousness is intuitively integrating phenomena over the entire brain into Subjects, meaning and sense.

Value—A Subjective image in the Right Brain Consciousness that intuitively shows how much appreciation a Subject or person would feel for an Action taken (such as a good or favor delivered) by another Subject or person.

Knowledge—Knowledge is the name of Subjective and/or Objective representations of conscious as well as sub- or pre-conscious information on phenomena.

Science—Science is the collective human endeavor to analyze or reduce the abstract Subject of certain phenomena into differentiated Objects. Individually it primarily emerges from the Left Brain Consciousness, although Science is the result of a combined, but not necessarily simultaneous, activity of the Left and Right Brain Consciousness. Science is created when Subjects in the Right Brain Consciousness are reduced to Objects in the Left Brain Consciousness, which allows the Left Brain Consciousness to detect contradiction with existing (formal) memory of phenomena and new (empirical) phenomena to exclude wrong knowledge and further reduce the Subject into Objects.

Bivalence—Bivalence is the Objective name I gave to the Subjective concept, notion or idea of phenomena being both Subject and Object at the same time, because the Right Brain Consciousness and the Left Brain Consciousness exist simultaneously when humans are conscious of phenomena. Being is fundamentally Bivalent, since human consciousness is bivalent, because the brain is bilateral. The equivalence of matter and energy in physics is just one, albeit a very convincing example of my Subject-Object and Left-Right Consciousness Bivalence concept or hypothesis.

Transcendence—Transcendence is the Objective name given to the Subjective concept, notion or idea of phenomena not being reducible to Objects only, unless the phenomenon is a pure tautological mental projection or pure Object. A pure Subject is irreducible to nothing (unless it's a pure Object, but then it is no Subject), so being remains Transcendent to language (and numbers). Residual measuring inaccuracy is an example of Transcendence.

Cult or symbolic religion—A cult or a symbolic religion is a collaborative human endeavor to intuitively synthesize phenomena into a (and eventually the) total Subject. Individually it emerges from the activity of the Right Brain Consciousness.

Culture—Human Culture is the combination of Cult and Science in their pure and mixed forms.

Free Will—Free Will is the Objective name given to the Subjective concept of Transcendence in understanding human behavior. Free Will is defined as the residual non-consistency, remaining after neurological, psychological, sociological and other Objective reductions of the scientific Subject of free human behavior.

Free Human Action—Free Human Action is the Subjective result of human Free Will.

Free Human Action (as well as free animal Action) is the pure Subjective source of real change. It is not (yet) deterministically reducible to Objective causes of change, such as heat, mechanical force, post-natal depression or lack of dopamine.

Free Human Action is defined as free, outside family and between families human behavior. One person families qualify as well as family.

Economics—Economics is the scientific discipline that tries to further reduce the Bivalence in Free Human Action. The Subject of Economics is Free Human Action, resulting from Free Will. Contrary to Psychology, Economy does not Objectify Free Will, but only Free Human Action.

Psychology—Psychology is the scientific discipline that aims at further reducing Bivalence in the Human Subject or psyche itself. The Subject of Psychology is the psyche. The endeavor is to further objectify and thus reduce the psyche in Objects such as Motivation, Emotion, sub- and pre-conscious projections and representations and finally name the remaining Subject Free Will. Therefore the Free Will, as well in Psychology as in Economics, remains the residual inconsistent, unreducible and therefore Transcendent Subject.

Motivation—Motivation is the Subjective source of immediate Action.

Emotion—Emotion is the Subjective source of future Action.

Fear—Fear is the Objective name for the generalized Subjective Emotion with negative valence. Fear is the Subjective force Objecting change.

Risk—A Risk is an Objectified Fear, grounded in Objective reality and expressed in language and/or numbers.

Desire—Desire is the Objective name for the generalized Subjective Emotion with positive valence. Desire is the Subjective force creating change and Subjecting to change. Also this word Subject, in ‘to subject’, is the same word Subject as in the concept and definition of Subject described and it has the inverse meaning of the word Object in ‘to object’.

Good—The adjective Good is used in a specific sense, not as a Subjective judgment of Value, but as an Objective adjective indicating that the specific character of the noun contributes to human specie's evolutionary fitness for survival.

Complementary Value Money—has an Objective structure that is the same structure that contributed to mankind's fitness for survival: dealing Objectively with Fear. Therefore it will probably also contribute to mankind's further fitness for survival. Therefore it is called Good Money, rather than good money.

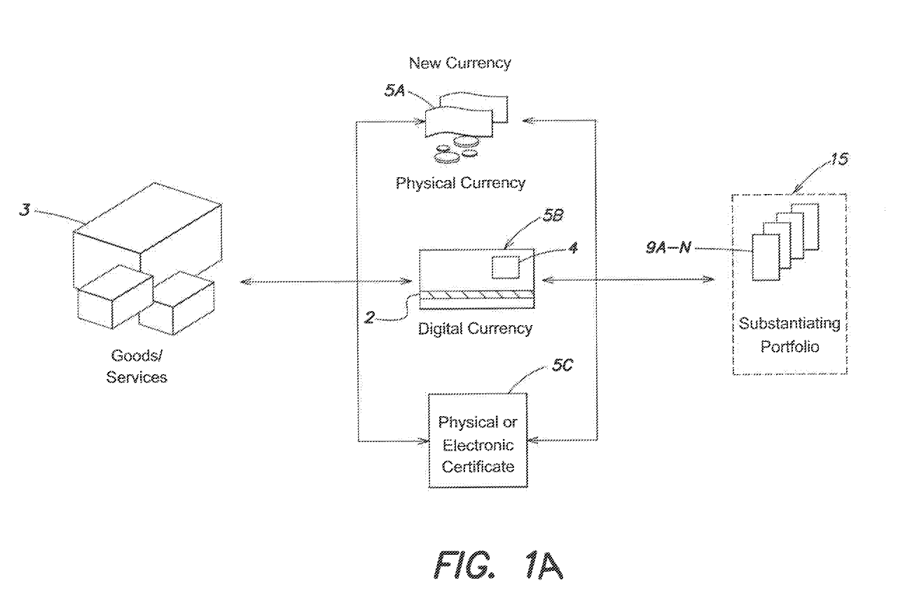

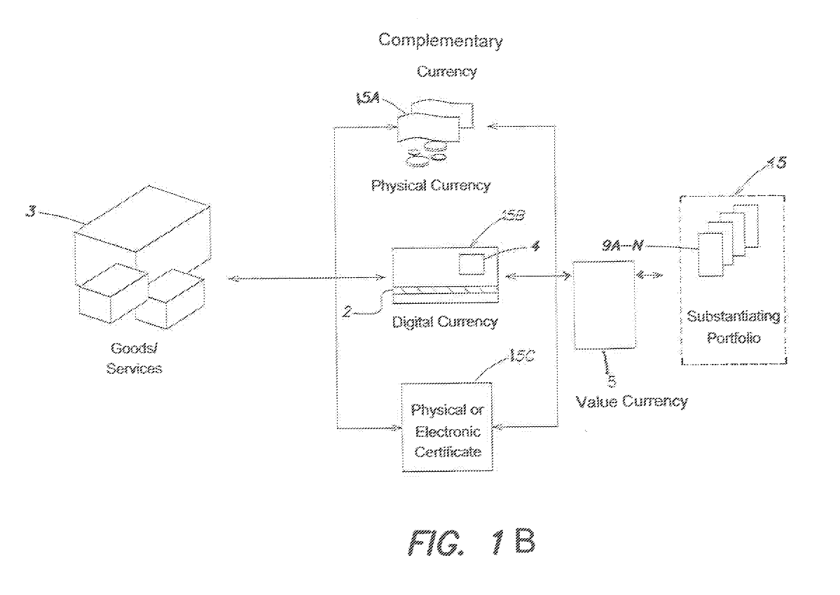

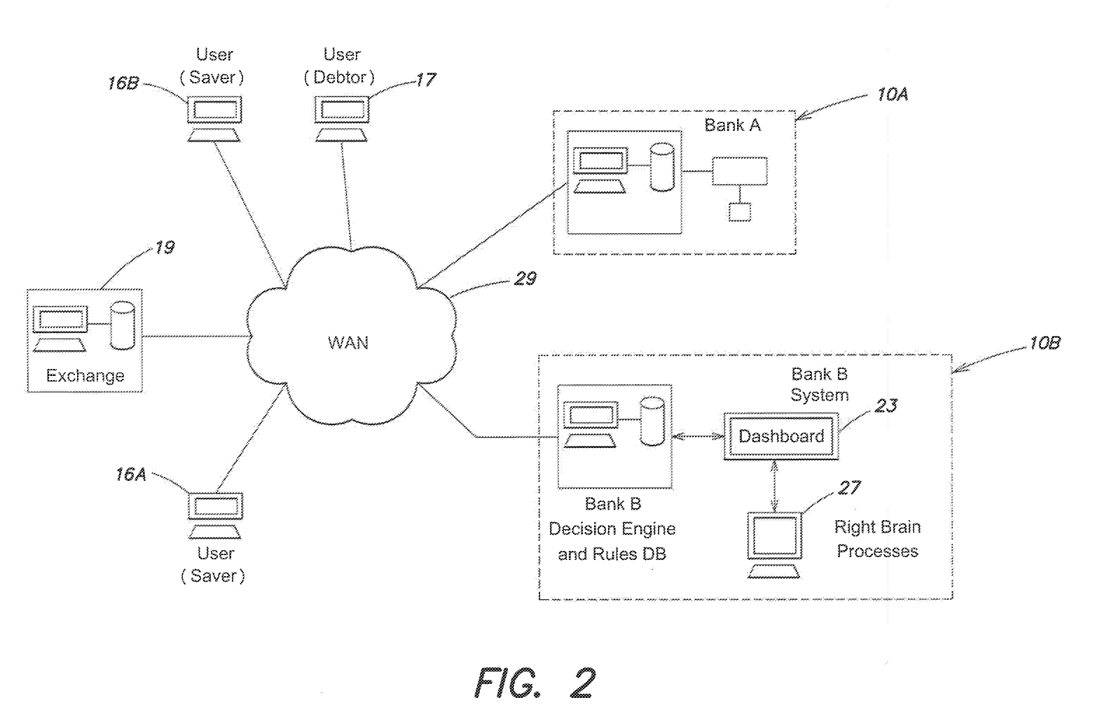

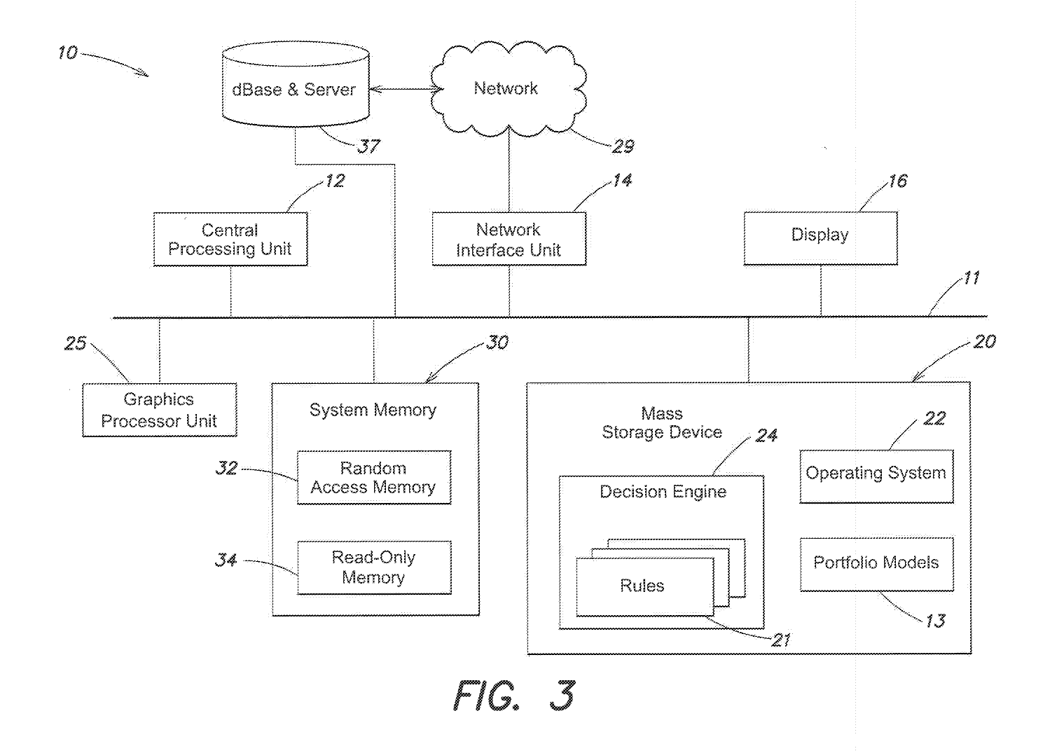

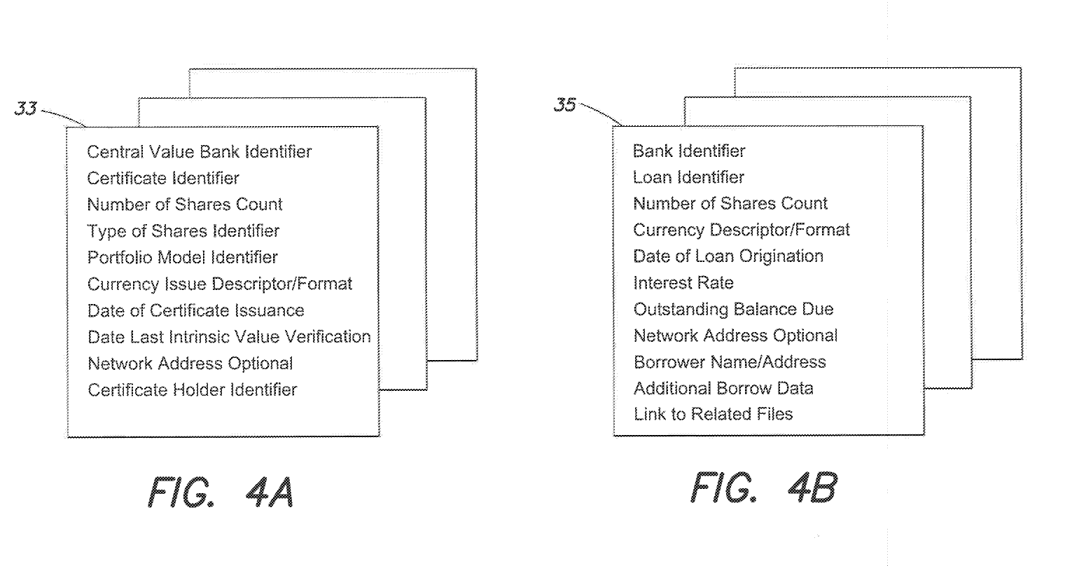

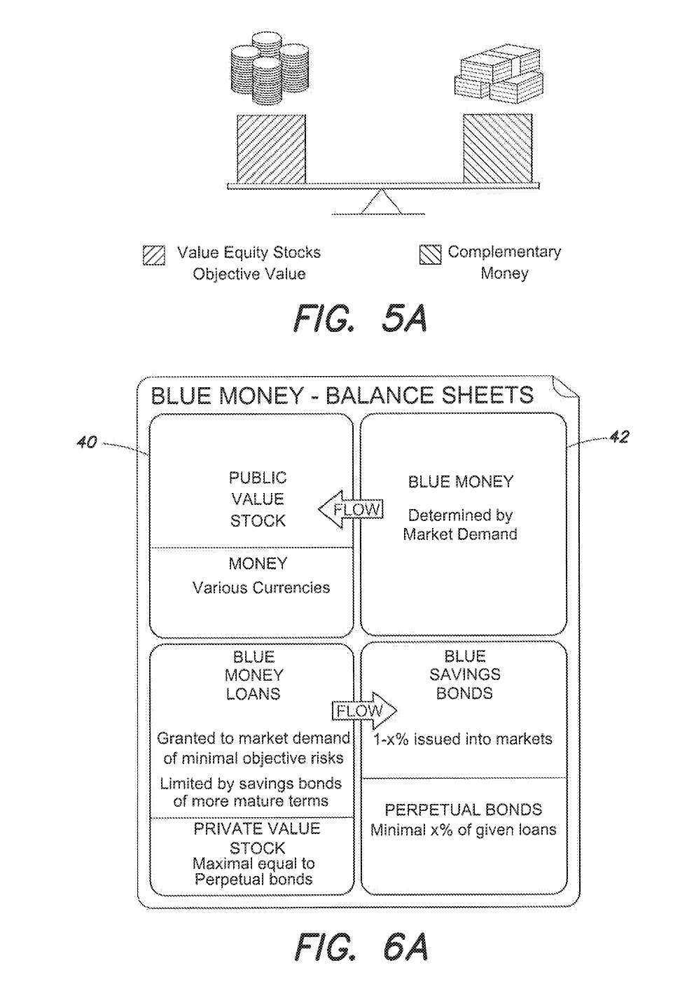

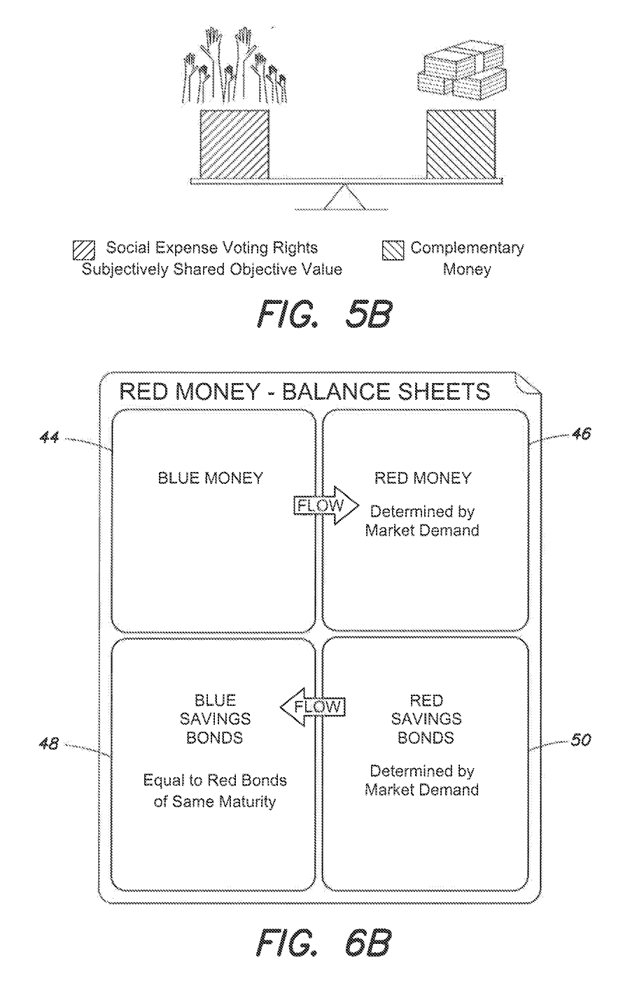

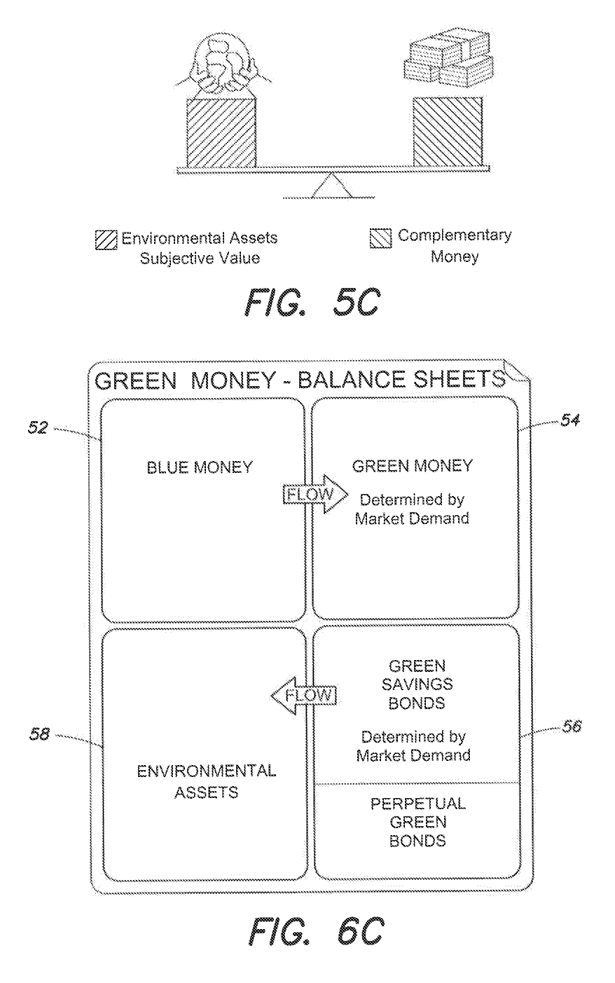

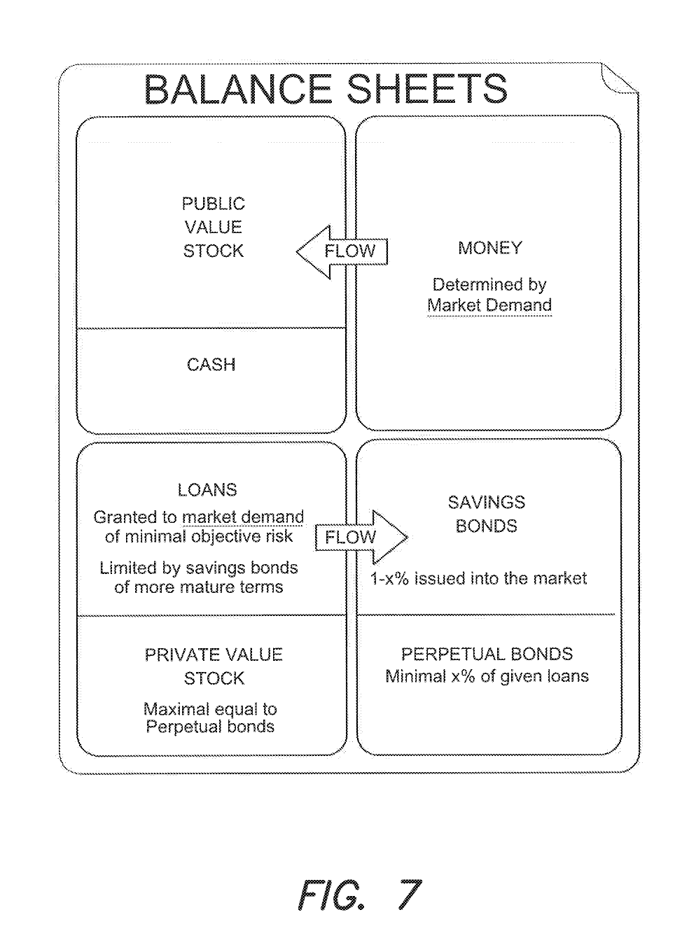

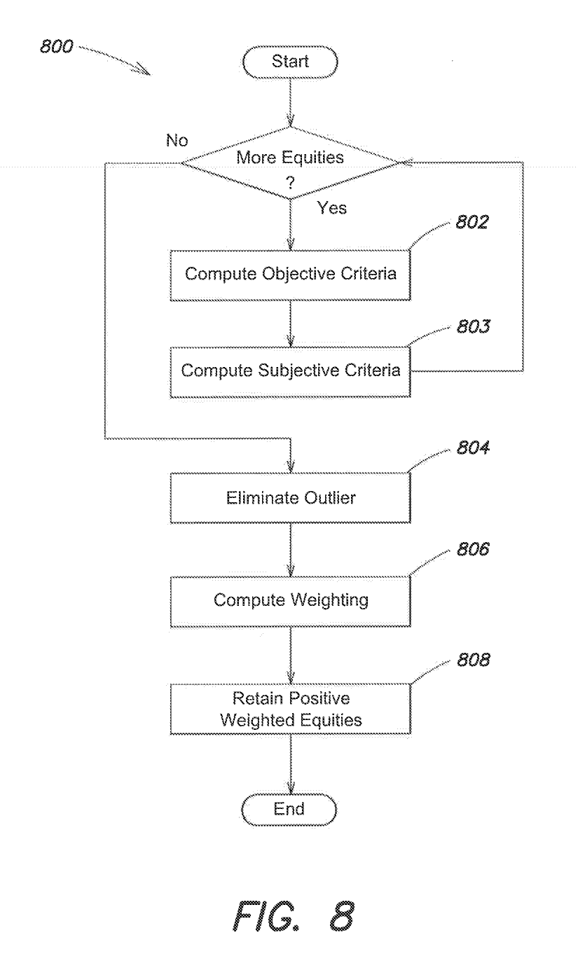

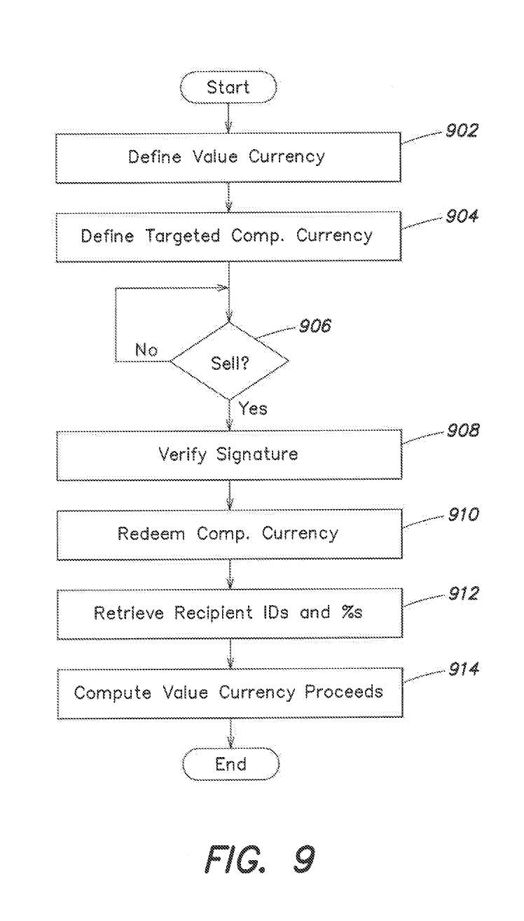

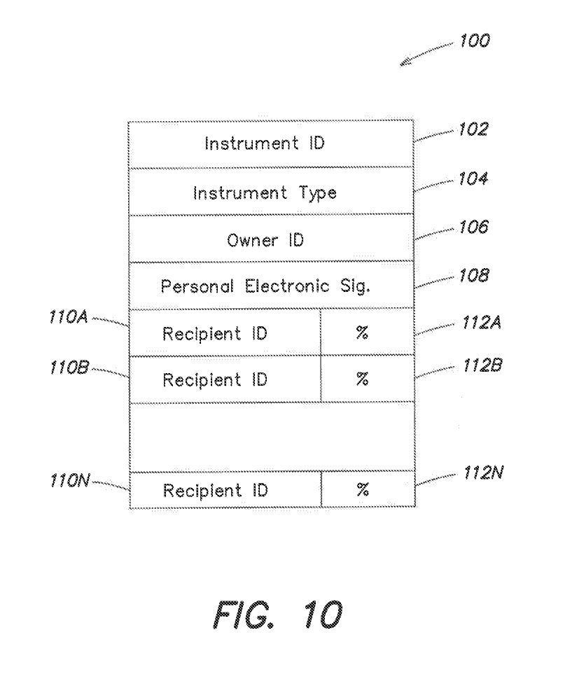

FIG. 1A illustrates conceptually the relationship between physical goods and/or intangible services, the new complementary currency described herein and the equity portfolio substantiating such new complementary currency. In the illustrative embodiment, the new complementary currency may be issued the form of a certificate for value shares. A central value bank issues the complementary currency as publicly quoted share certificates of its own equity investment fund. These share certificates of the complementary central value bank can be wired or exchanged as paper or coins (possibly featuring an electronic chip) and are then used as currency, freely without legal tender law obliging acceptance of it.

The equity investment fund of the complementary central value bank comprises, in one embodiment, an equity stock portfolio guaranteeing long term value through safety margin between objective, intrinsic stock value and subjective market value. The equity stock portfolio that substantiates the value of the complementary new currency is a value stock portfolio, meaning it is picked or selected and reselected by choosing equity stocks that have relatively the best safety margin between objective, intrinsic value and subjective market value. The selection algorithms and their computer implementation are described herein.

in addition, the stock portfolio's foreign currency distribution is selected with the objective to hedge the foreign exchange risk and the risk of importing monetary instability from foreign currencies, as well as from the hosting fiat currency, and by choosing the currency distribution to reflect the currency distribution of the trade expressed in other currencies, as traded by the community using the new complementary value currency.

The short term risk of value loss is hedged by the central value bank arbitrating, directly or through its partnering market makers, between the market price of the new value currency (being the publicly quoted share certificates) and the intrinsic value of its own value currency. The intrinsic value of its value currency is modeled based on the market price of the underlying stock(s) in its stock portfolio or on the intrinsic value of such stock portfolio. Arbitrating between new value currency's market value and the intrinsic value based on the market value of the underlying stock allows for realization of arbitration profit, shared between partnering banks (restoring their balance sheets) and social non-profit organizations (as a free tax for social goals). In any case, the arbitration hedges the short risk of the currency and stabilizes the value of the currency, by steering it towards its intrinsic value. The information on market value, intrinsic value based on market value and/or intrinsic value of the underlying stock portfolio can be continuously communicated through electronic means, such as an smart chip embedded in physical, tangible money, allowing the trust to optimally, build by having continuous transparency.

Collaborative loan and savings are achieved directly from the complementary central value bank. In order to guarantee 100% fraction and guarantee value substantiating money, saving are accepted by bank partners but converted into value currency and held directly on the balance sheet of the central value bank, from which loans are also originated.

The design rules, specifications for loans, savings and balance sheet structure of the central value bank, as well as the arbitration and stabilization methods and the stock selection methods, may all be implemented with a number of software algorithms which execute in conjunction with a decision engine and a plurality of predefined rules defining models for the new currency and central value banking system as disclosed herein.

The method and system described above processes physical and tangible goods more efficiently and more effectively. Concept of utilizing a volatile asset class, such as equity stock, to substantiate the intrinsic value of a new complementary currency is not obvious and novel. While the systems and methods described herein may be computer implemented the techniques also require skill and expert understanding in the fields of neuropsychoiogy, history and economics. The integration of software, electronics, mechanics, economics, neuropsychology and history allows solving this technical problem of inefficiently (and sometimes even ineffectively) processing physical tangible goods in a practical manner.

In accordance with the foregoing, disclosed is a system and technique for establishing a Complementary Value Currency and a Free-Market Banking System. In accordance with the disclosure. Complementary Value Banking applies a net of Objective rules and processes, implementable as executable software embedded in a computer system, defining Complementary Value Banking. The Complementary Value Banking System consists of a Central Value Bank, Bank Partners also called Value Banks and a Community using the Value Certificates as Currency.

The Central Value Bank is a publicly quoted Value Fund, a fund holding and trading equity stock, optimizing its portfolio for maximal Safety Margin between Intrinsic Value and Market Value. The Central Value Bank's public stock functions as Money in order to be used by the Community as a Complementary Value Currency. Value Banks are commercial banks that partner with the Central Value Bank to broker the Value Currency, Saving Bonds as well as loans granted directly from the Central Value Bank's balance sheet.

The exchange rate of the Value Currency is the stock quote of the Central Value Bank. A stabilization procedure is disclosed that stabilizes the Market Value of the Complementary Value Currency, by arbitrating between Intrinsic Value and Market Value, through partnering Value Banks. The stabilization procedure also stabilizes the Legal Tender Currency and allows for stable restructuring of distressed commercial banks.

The fraction of Value Stock selected varies over Currencies regions, in order to hedge the risk of Monetary Confusion created by other currencies and therefore protecting the competitive strength of members of the Community.

The Complementary Value Banking System is implemented utilizing computer systems, and program products and methods in which the Value of money is Objectified, secured and stabilized by the Intrinsic Value of underlying assets of the Certificates used as Money through the Complementary Value Banking System.

System Implementation

As noted previously. FIG. 1A illustrates conceptually the relationship between physical goods/intangible services 3 (hereafter goods), the new complementary currency 5 described herein and an equity portfolio 4 substantiating such new complementary currency. Specifically, goods 3 may comprise any tangible items or services which have value and may be exchanged or processed for a form of the new complementary currency 5 whose value is maintained stable by equity portfolio 45 in accordance with the new value banking system disclosed herein. New complementary currency 5 may take the form of physical notes or coins 5A, or a physical apparatus 5B, or a physical or electronic certificate 5C. The currency 5 in the form of physical apparatus 5B may be implemented as a currency token which, in one embodiment, may be substantiated with a smart card having one or both of a magnetic strip 2 or smart chip 4 embedded thereon for communicating with any of the systems 10 within the new value banking system. Magnetic strip 2 or smart chip 4 may be utilized as links or communication mechanisms to substantiate or verify the value of the currency with the value banking system. Certificate 5C may be in the form of a physical certificate, such as a traditional stock certificate or may be an electronic certificate stored in a computer memory and having a data structure associated therewith similar to that described in FIG. 4A herein. Equity portfolio 15, as described elsewhere herein, may be comprised of a plurality of individual equity instruments 9A-N. As explained elsewhere herein, equity portfolio 15 and its constituent equity instruments are selected based on a model and one or more associated rules which are used to collectively implement in an automated manner the bylaws of the new value central bank. The equity portfolio 45 provides the underlying asset basis for the amount of value of the currency as issued.

FIG. 1B illustrates conceptually the relationship between physical goods/intangible services 3 (hereafter goods), new targeted objective complementary currency 15, the previously described complementary value currency 5, and an equity portfolio 4 substantiating currencies 5 and 15. Specifically, goods 3 may comprise any tangible items or services which have value and may be exchanged or processed for a form of the new complementary currency 15, which is legally and technically coupled to value currency 5 and may be interchanged therewith at any time, including at the point of exchange for goods 3. Value currency 5, in turn, has objective value substantiated or maintained stable by equity portfolio 45 in accordance with the new value banking system disclosed herein. New complementary currency 15 may take the form of physical notes or coins 15A, or a physical apparatus 15B, or a physical or electronic certificate 15C and may be associated with a specific color which corresponds to the targeted objective or cause which with the underlying assets are associated. The currency 15 in the form of physical apparatus 15B may be implemented as a currency token which, in one embodiment, may be substantiated with a smart card having one or both of a magnetic strip 2 or smart chip 4 embedded thereon for communicating with any of the computer systems 10 within the new value banking system. Magnetic strip 2 or smart chip 4 may be utilized as links or communication mechanisms to link the targeted objective complementary 315, e.g. red money or green money, to complementary value currency 5, as well as to substantiate or verify the value of the currency with the value banking system. In various embodiments, smart chip 4 or other selectively configurable electronic device, such as a switch, on physical apparatus 15B may be utilized to exchange the value of a targeted objective complementary currency 15 to a complementary value currency 5, as illustrated in FIGS. 6A-C. Certificate 15C may be in the form of a physical certificate, such as a traditional stock certificate or may be an electronic certificate stored in a computer memory and having a data structure associated therewith similar to that described in FIG. 4A herein. In various embodiments, the use of electronic signature with a certificate 15C at the time of spending or exchanging currency 15 may be used to indicate the financial proceeds allocation or asset allocation of the value associated with the complementary currency 15.

Equity portfolio 45, as described elsewhere herein, may comprise a plurality of individual equity instruments 9A-N. As explained elsewhere herein, equity portfolio 45 and its constituent equity instruments are selected based on a model and one or more associated rules which are used to collectively implement in an automated manner the bylaws of the new value central bank. The equity portfolio 45 provides the underlying asset basis for the amount of value of the currency as issued.

The practical implementation of blue, red and green money may be in software or hardware. People may set and change their preferences on their personal computers, smart phone or tablets, which are applied automatically at the moment the money or bond is acquired, the green and red bond's preferences remain, however, fixed through their live, unless they are perpetual bonds, then they are resettable at purchase on the secondary market. The proceed allocation signature that automatically assigns financial proceeds to a distribution of red and green goals can be done using a smart phone that communicates wireless with the payment terminal of a store or by a software module communicating with professionally used payment management or accountancy software.

Any of new complementary currencies 15 (blue, red and green money) may be implemented in paper money or plastic money or some other physical manifestation token of money such as a virtual certificate viewable with a smart phone or other computing device or as previously described with reference to currencies 15A-C of FIG. 1B. In other embodiments, the transfer of complementary currency from one color to another or a signature for allocation may be acquired through the use of a physically configurable chip 4, semiconductor or electronic device or through software.

FIG. 2 illustrates a network environment in which a free-market banking system in accordance with the disclosure may be implemented. As illustrated in Figure, bank systems 10A-B, users 16A-B representing savers, user 17 representing a debtor, as well as exchange 19 are all interconnected via a computer network topology 29, typically a combination of LAN and WAN networks, i.e. the Internet, to facilitate electronic financial transactions. Note that at least one of bank 10A or bank B are part of the free-market bank system described herein, operating in accordance with the bylaws incorporating the free-market bank protocol. Such protocol may be implemented with a series of computer algorithms and threshold values which are stored by the bank the form of a collection of rules which may be acted upon by a decision engine and utilized in conjunction with the banks various day-to-day procedures and decisional processes as it transacts business. FIG. 2 further illustrates that each of banking systems 10A-B may comprise one or more additional computer systems 27, databases and servers 37 and/or dashboard displays 23.

FIG. 3 illustrates conceptually a computer architecture 10 which may be implemented any of the systems illustrated in FIG. 2 to perform methods described. Hs illustrated in FIG. 3, computer architecture 10 comprises a central processing unit 12 (CPU), a system memory 30, including one or both of a random access memory 32 (RAM) and a read-only memory 34 (ROM), and a system bus 11 that couples the system memory 30 to the CPU 12. An input/output system containing the basic routines that help to transfer information between elements within the computer architecture 10, such as during startup, can be stored in the ROM 34. The computer architecture 10 may further include a mass storage device 20 for storing an operating system 22, data and various program modules, such as the decision engine 24, rules 21 and portfolio models 13.

The mass storage device 20 may be connected to the CPU 12 through a mass storage controller (not illustrated) connected to the bus 11. The mass storage device 20 and its associated computer-readable media can provide non-volatile storage for the computer architecture 10. Although the description of computer-readable media contained herein refers to a mass storage device, such as a hard disk or CD-ROM drive, it should be appreciated by those skilled in the art that computer-readable media can be any available computer storage media that can be accessed by the computer architecture 10.

By way of example, and not limitation, computer-readable media may include volatile and non-volatile, removable and non-removable media implemented in any method or technology for the non-transitory storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer architecture 10.

According to various embodiments, the computer architecture 10 may operate in a networked environment using logical connections to remote physical or virtual entities through a network such as the network 29. The computer architecture 10 may connect to the network 29 through a network interface unit 14 connected to the bus 11. It will be appreciated that the network interface unit 14 may also be utilized to connect to other types of networks and remote computer systems. In one embodiment, network interface 14 includes the necessary transceiver hardware (not shown) to communicate wirelessly with other network devices or processes. The computer architecture 10 may also include an input/output controller for receiving and processing input from a number of other devices, including a keyboard, mouse, or electronic stylus (not illustrated). Similarly, an input/output controller may provide output to a video display 16, a printer, or other type of output device. A dedicated graphics processor 25 unit may also be connected to the bus 10.

As mentioned briefly above, a number of program modules comprising sequences of executable instructions, and data files may be stored in the mass storage device 20 and RAM 32 of the computer architecture 10, including an operating system 22 suitable for controlling the operation of a networked desktop, laptop, server computer, or other computing environment. The mass storage device 20, ROM 34, and RAM 32 may also store one or more program modules. In particular, the mass storage device 20, optionally in conjunction with RAM 32, may store the executable instructions that program modules comprising decision engine 24 for execution by the CPU 12. The decision engine 24 can include software components for implementing portions of the processes discussed in detail with respect to FIG. 8 as well as the other computational communication properties described herein 10. According to embodiments, the decision engine 24 may also be stored on the network 29 and accessed by any computer within the network 29. Also patent database 37 and its accompanying server process may be coupled directly to the bus 11 of system 10 or may be remotely connected thereto via network 29.

The software modules may include software instructions that, when loaded into the CPU and executed, transform a general-purpose computing system into a special-purpose computing system customized to facilitate all, or part of, the volatility index generation techniques disclosed herein. As detailed throughout this description, the program modules may provide various tools or techniques by which the device or computer architecture may participate within the overall systems or operating environments using the components, logic flows, and/or data structures discussed herein.

The CPU 12 may be constructed from any number of transistors or other circuit elements, which may individually or collectively assume any number of states. More specifically, the CPU 12 may operate as a state machine or finite-state machine. Such a machine may be transformed to a second machine, or specific machine by loading executable instructions contained within the program modules. These computer-executable instructions may transform the CPU 12 by specifying how the CPU 12 transitions between states, thereby transforming the transistors or other circuit elements constituting the CPU 12 from a first machine to a second machine, wherein the second machine may be specifically configured to manage the generation of portfolios and/or decisions. The states of either machine may also be transformed by receiving input from one or more user input devices associated with the input/output controller, the network interface unit 14, other peripherals, other interfaces, or one or more users or other actors. Either machine may also transform states, or various physical characteristics of various output devices such as printers, speakers, video displays, or otherwise.

Encoding of executable computer program code modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the system memory when the software is encoded therein. For example, the software may transform the state of transistors, capacitors, or other discrete circuit elements constituting the system memory.

As another example, the storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

FIG. 4A illustrates conceptually a data structure 33 which may be stored by the Central value Bank 10B in association with a particular value share certificate representing the new value currency in accordance with the disclosure. Specifically, data structure 33 may be implemented as an object, record, file or other storage construct maintainable in accessible memory and may comprise one or more fields or parameters which help identifying the particular instance of new currency. Such fields or parameters may be utilized to identify one or more of the following self-explanatory parameters:

### Bank Identifier

### Certificate Identifier

### Number Of Shares Count

### Type Of Shares Identifier

### Portfolio Model Identifier

### Currency Descriptor/Format

### Date Of Certificate Issuance

Date Last intrinsic Value Verification

### Network Address (Optional)

### Certificate Holder Identifier

A plurality of data structures 33, each in association with a certificate of shares of new currency, may be stored in database 37 or other memory of a New Value Bank system 10 in accordance with the disclosure.

In a similar manner, FIG. 4B illustrates conceptually a data structure 35 which may be stored by the Central value Bank 10B in association with a loan or promissory note in accordance with the disclosure. Specifically, data structure 35 may be implemented as an object, record, file or other storage construct maintainable in computer memory and may comprise one or more fields or parameters which help identifying the particular instance of new currency. Such fields or parameters may be utilized to identify one or more of the following self-explanatory parameters:

Bank Identifier

Loan Identifier

Number Of Shares Count

Type Of Shares Identifier

Portfolio Model Identifier

Currency Descriptor/Format

Date Of Loan Origination

Interest Rate

Outstanding Balance Due

Network Address Optional

Borrower Name

Borrower Address

Additional Borrow Data

Link To Related Files

A plurality of data structures 33, each in association with a certificate of shares of new currency, may be stored in database 37 or other memory of a New Value Bank system 10 in accordance with the disclosure.

Good Money

Money is the Object that hedges the Fear for loss of Value over longer time in savings as well as shorter time as currency. Good Money does that well. Objects have neuropsychologically, evolutionary evolved to deal with Fear. Therefore for Money to be Good Money, it should have Objective Value.

Government and private debt has no Objective Intrinsic Value but an unstable Subjective Market Value only. Fiat Money backed by debt does therefore not secure Value over longer time. The Subjective Market Value of Fiat Money based on debt without Intrinsic Value is not stabilized Value over short term, e.g. by saving or reminting, either. Therefore the contemporary Fiat Money does not secure Value over shorter neither longer time and is really bad Money. It causes Monetary Confusion, economic cycles, recessions and depressions.

Physical Gold Money has worked quite well as Money, because the Subjective Value of gold is relatively stable and it is further stabilized through its property of being infinitely remeltable without loss, although gold has no objective Value. Physical Gold Money is the best money of the prior art, but still is no Good Money. The Spanish inflation in the 16^{th} century, resulting from a massive overseas inflow of precious metals proves it.

Non-Physical Gold Money has the problem of lack of continuous and transparent auditability and is therefore liable to fraud. Therefore it is not Good Money either.

The disclosure describes a system and technique for implementing Good Money. In order to be Good, Money should have Objective Value and in order to be a Good Currency it should as well enjoy Subjective trust among the members of the community. The Objective Value of the Money described here results from the Intrinsic Value of a Value Stock Portfolio used as the asset underlying the Certificate used as Money. The continuous and transparent auditability of a public stock portfolio is Objectively trustworthy and therefore allows for building of Subjective trust among the members of the community using the Money as Currency.

Value Banking System

Disclosed is a method and procedure for a Complementary Value Banking System, embedded in software, securely exchanging and storing saved Value over time in money and savings bonds enabling trustworthy exchange of Value through its community currency.

Complementary Community Currency

Disclosed is also a method to allow Subjective trust in the Banking System and its Currency to grow among the members of the Currency Community. This Community Currency is freely and voluntarily chosen by members of the community and is Complementary to the Legal Tender Currency.

Value Certificate acting as Money

The Central Value Bank is a publicly quoted investment fund. The publicly quoted shares of the fund are the Certificates that are Good Money and therefore are used as Community Currency.

The publicly quoted shares of the fund are the Value Certificates or the Money, the stock quote form the exchange rate. The continuous publicly trading of the Money allows for the continuous exchange for other currencies, allowing the Subjective trust to grow and the Objective stabilization mechanism to be executed, under direction of the Central Value Bank.

Value Money Supply, Money Price Stabilization and Bank Partner arbitration

Capital or Value is brought into the Central Value Bank by Community members or savers seeking trustworthy money when they buy Value Money and use it as Value Currency or to buy Value Saving Bonds.

Bank Partners, also called Value Banks, broker the Value Currency to Community members by arbitrating the Value Currency in the market. Therefore Value Banks are allowed, from time to time, at discrete moments in time determined at the discretion of the Central Value Bank, to buy Value Money from the Central Value Bank at a premium to the Money's Intrinsic Value (determined by the Market Value of the Value Stock Portfolio), only when the Market Value of the Value Currency is above its Intrinsic Value and subsequently sell it at the higher market price, decreasing the Money market price. And similarly to sell Value Money at a discount to its Intrinsic Value, only when its Market Value is under its Intrinsic Value, while buying it at an even lower market price, increasing the Money market price. The continuous swing of the market price around its Intrinsic Value is stabilized by this Stabilization Procedure, as indicated in FIG. 6.

The profit made by selling Value Money at a premium to its Intrinsic Value to Value Banks flows back to the Currency Community, as described further. The profit Bank Partners make by buying Value Money at a discount to Market Value and selling it at Market Value is used by Bank Partners to repair their balance sheets, which are typically damaged by government debt or other toxic assets. Similarly with profit made when Bank Partners buy Value Money at Market Value, below its Intrinsic Value and sell it to the Central Value Bank at a discount Intrinsic Value that is still higher than the Market Value.

This arbitration by Banking Partners aligns the money supply to the demand for money, using the pricing mechanism of the free market.

Hedging the Long Risk of Value Loss

Securing Value over longer time is accomplished by Objectively modeling the Intrinsic Value of the stocks and selecting those stocks that have the smallest (and even negative) purely Subjective component in their Market Value.

Stocks have Objective Intrinsic Value. The decrease of the Subjective component in the Market Value of the Value Currency is hedged by selecting the stock portfolio to maximize Safety Margin. The Safety Margin is the margin between the Objective Intrinsic Value of the stock and its Subjective Market Value, as for example simply expressed in the price earnings ratio.

Selecting a portfolio with maximal Safety Margin, minimizes the risk of loss of Value over the longer time, as has been successfully proven by Graham and Buffet.

Hedging the Short Risk of Value Loss

The arbitrating between Objective intrinsic and Subjective Market Value, regularly done by Bank Partners to manage the Money Supply is a the stabilization procedure a Currency needs to stabilize ever fluctuating Subjective Market Value (as saving and reminting were in History). The short term fluctuating Subjective Market Value is stabilized around the Objective Intrinsic Value which secures the Value over the longer term. This hedges the short term risk of loss of Value.

Hedging the Monetary Risk of Other Currencies

An important contributor to the volatility of stock prices is the volatility of the Value of Money.

When the Value of the currency in which the Market Value of the stock is expressed, diminishes the price of the stock will increase, as is the case with the price of any other good.

The geographical selection of the Value Stock Portfolio is done in such way that it reflects the importance of the trading partners. When trade with a certain foreign currency is x %, then x % of the Value Stock Portfolio is selected in that foreign currency.

When that foreign currency decreases Value, the foreign stock will increase in price and the Value Currency will remain constant in Value, since the price increase compensates the decrease of Value of the foreign currency, reflected in its exchange rate.

A product bought or sold in such foreign currency that decreases Value will increase price, the decreasing exchange rate compensate this increase.

The average competitive strength of the community's economy is naturally hedged by this simple procedure and Monetary Confusion is not imported, neither are the five related disadvantages.

Hedging Risk of Government and Private Market Manipulation

Contemporary governments have the power, through their (loosely) controlled central banks, to increase the Money Supply of their Fiat Currency. Also private speculators can increase the Money Supply by loaning Fiat Money. Shorting this loaned Currency destabilizes the Value of that Fiat Money, which Market Value will subsequently converge closer to its Intrinsic Value, as e.g. the 1992 Soros speculation against the Pound proved.

The risk of government or private shorting with loaned Value Money, against the Complementary Value Currency is hedged by making the Value Currency a full reserve currency. When Value Money is loaned, its Money Supply therefore does not increase. Every downwards manipulation of the Market Value, has necessarily first an upwards effect on the Market Value, because the full reserve currency needs to be bought before it can be sold, it cannot be created in a different way by the manipulator. Any manipulation of the Market Value of the Value Currency can be arbitrated by the Central Value Bank, through its Bank Partners, transferring Value from the manipulator to the Community and the Partner Banks.

Hedging the Risk of Value Loss Protects Against Financial Crises

All risks of absolute Value loss are hedged. Relatively, the Value of the Value Currency could still vary based on the expected economic outlook for the communities trading in that Value Currency, but this is a relative variation which is a property of Value itself. Value is relative. It is the share within future production as a gratuity for contribution to previous production. Therefore Value Money Objectively hedges against all loss of Value and is thus Good Money.

Good Money does not create Monetary Confusion, since its Value is stable. Crises are the result of Monetary Confusion. The Value Currency also protects against imported Monetary Confusion. Therefore the Complementary Value Currency is an Objective hedge against Financial Crises.

Not only the Currency Community, adopting the Value Currency, but also its surrounding host community that distrusts the new Money and does not adopt it but uses the Fiat Currency instead, is protected from instable crises, such as Hyperinflation. The exchange rate with the host community's Fiat Currency is controlled and kept stable, providing the Subjective trust for the host community's Fiat Currency, that it can always be traded in for Value, although this Value will decrease at the host currency's inflation rate.

The maximal inflation rate in the host community's Fiat Currency can be controlled by allowing to build up the market premium of the Complementary Value Currency over a relatively longer period and then arbitrate it back to zero, effectively creating a brake on the speed of adoption of the Value Currency and stabilizing the host community's inflation at the maximal premium of the Value Currency's Market Value above its intrinsic Value.

The Balance Sheet Structure of the Central Value Bank

Guaranteeing the full reserve character of the Value Money is done by bringing Savings and Loans directly on the balance sheet of the Central Value Bank.

Money is only created when the Bank Partners wire other currencies to the Central Value Bank who is then buying Value stock with these other currencies and creates full reserve Money in return, wired to the Value Bank. This is indicated by the upper Flow arrow in the balance sheets represented in FIG. 7.

Value Currency (as well as some other currency) is held in reserve at the active side of the upper (as well as lower) balance sheet, for trading purposes.

The profit made by selling or buying Value Money at a premium or discount to its Intrinsic Value flows to the Community. This profit adds to a separate balance sheet not represented in FIG. 3, the balance sheet of the Community Representing Entity, discussed further.

The profit or loss made by the increase or decrease of the Market Value of the Value Stock flows to the Intrinsic Value of the Value Sock Portfolio and as such directly to the holders of the Certificates representing the assets on the upper balance sheet. These are the holders of the Money, hence the members of the Currency Community.

The increase of Value over longer time of a Value Stock Portfolio, as proven by Graham and Buffet, secures the Value of the Complementary Value Currency over the long term, as arbitrating by Banking Partners secures its Value over the short term.

Loaning and Savings

Value Bank loans are granted in Value Currency. These Value Loans are granted directly from the Central Value Bank's second balance sheet, the lower balance sheet in FIG. 3.

The Bank Partners act as brokers when selling these loans to the Currency Community. These earned commissions vest at the moment of loan pay out. This has the extra advantages that income for distressed commercial banks, partnering with the Central Value Bank is accelerated. These accelerated profits allow for reparation of the balance sheets of these banks, which are typically distressed due to impairments to government bonds and other toxic assets.

The Central Value Bank finances the Value Loans, expressed in its own Value Currency, by issuing Saving Bonds in the market, brokered by its Banking Partners, the Value Banks. The risk associated with loan impairments, is covered by issuance of Perpetual Saving Bonds, also brokered by the Value Banks.

As part of this invention, a rule is applied (and transparently communicated to the public) fixing a minimal boundary condition on the percentage of outstanding Value Loans covered by Perpetual Saving Bonds. A fraction of Savings Bonds may be held in cash for practical and trading reason. The amount of Perpetual Saving Bonds is the maximal boundary condition for Private Equity Value Stock, as shown in FIG. 3.

The profit or loss generated by the Value Loans and the Private Equity Value Stock assets on the lower balance sheet of FIG. 3, are allocated to the holders of the Perpetual Saving Bonds.

The interest rate of the Value Saving Bonds is determined by its market price, when issued.

A liquidity rule under the Value Banking System is that Saving Bonds redemption terms should always be pro rate more mature than Value Loans redemption terms.

The interest rate charged on Value Loans is that same interest rate, increased with the commission for Value Banks and a margin reflecting the average loan impairment percentage, which is periodically fixed and transparently communicated to the public.

Enforcing Rules of Free-Market Banking

The Value Banking System rules are freely and voluntarily applied when licensing the money concepts described herein as Central Value Bank, Bank Partner, Currency Community member or Currency Community Representative Organization. E.g. 1) the Central Value Bank assets and liabilities can solely consist of those represented on FIG. 3 while respecting the boundary conditions as indicated in this disclosure, or 2) the valid tendering of the Value Currency as a means of settling debt, is freely and voluntarily agreed among Currency Community members when they buy the Value Currency or 3) the redistribution of profits (as a Free and Voluntary Tax, when distributed to the Currency Community) is freely and voluntarily agreed when buying Value Currency or Value Saving Bonds. No new legislation is necessary to implement this invention.

Value Investing Rules

Public, as well as Private Equity, Value Shares are selected based on maximal relative Safety Margin or margin of safety between Subjective Market Price and Objective Intrinsic Value, taking into account various boundary conditions. This Safety Margin optimization criterion can be the price earnings ratio, or the method disclosed or any other criterion that Objectively expresses Fear for loss of Intrinsic Value of the Value Share. Under the rules of the Value Banking System the Central Value Bank is not allowed to include purely Subjective criteria, expressing Desire for gain of Market Value. Therefore the optimization criterion expresses an Objective Safety Margin and not Subjectively expected or imagined gain. A Value Certificate can only be successful or Good Money, if Fear is Objectively hedged, since evolution has learned us that the successful way to deal with Fear is to Objectify it.

Boundary conditions take only into account Objectified real risk, such as available market liquidities to hedge illiquidity risks, currency geographies to hedge contamination by the Monetary Confusion in other currency geographies, balance strength to hedge financial risks, etc.

The Safety Margin may be calculated as Graham and/or Buffet do, although not obligatory. Under the rules of the Value Banking System the Value Investing Rules applied by the Central Value Bank should be Objective and transparently communicated to the public, while the stock portfolio itself is not published, unless from time to time as required by law and other regulations, the Central Value Bank is bound to.

Collaborative or Cooperative

Good banking should be an Objective Left Brain activity that does not Subjectively speculate and therefore does not Desire profit or Value, it only hedges the Fear of money losing Value and not being trustworthy.

Good banking is therefore not entrepreneurial, but is a collaborative effort of Objectively securing Value in money. The preferred implementation of the Central Value Bank is therefore a cooperative bank and not a private enterprise.

Also the redistribution of the Free Tax, the profit transferred to the Community Representing Organization and realized by the Central Value Bank on the arbitration, executed by Partnering Banks requires a cooperative attitude or structure.

Under the rules of this disclosure holders of Saving Bonds can assign their share in the future Free Tax Profits, to specific community projects. Their share corresponds to the percentual share they own, at that future moment in time when profits are redistributed, in the total Saving Bonds on the passive of the lower, second balance sheet of the Central Value Bank.

The Community Representing Organization organizes the selection of projects that candidate as beneficiaries of these redistributed profits, purely on Objective grounds, without Subjective (e.g. political) preferences. The Community Representing Organization also organizes the control and pay out of the moneys to these projects, factually becoming a redistribution organ of Free Tax.

Excluded Activities and Related Activities

Some financial activities may be organized under the same brand as that of the Community Representing Organization and/or the Central Value Bank, but with a different and entirely separated balance sheet, meaning no liabilities or risks may be shared between these activities and the Central Value Bank. Such activities are called Excluded Activities, since they are excluded from the balance sheet of the Central Value Bank and Related Activities since they can be executed under the same brand as that of the Community Representing Organization and/or the Central Value Bank.

Insurance activity is such a Related Activity. It becomes Value Insurance Activity when insurance risks are Objectified and investment of the insurance premium is done using Value Investing. A Left Brain Interface should preferably be used to guide the investment as well as the insurance process. A potential pay out under a Value Insurance claim should be limited in time and amount.

Life insurances and life annuity are Related Activities that should be separated from Value Insurance Activity, since life and its duration is not Objectifiable, with sufficiently high accuracy or low remaining pure Subjectivity. After all life is the Objective name of the Subjective transcendence in nature over material reality.

Dashboard Interfacing

In accordance with the disclosure in the systems disclosed herein, all banking processes may be automated in software, and, regardless of software automation, may be maximally left brain similar to other computer traditional user interfaces. The right brain processes may be interfaced through a management dashboard 23, as illustrated in FIG. 2, which functions as, an interface between bank management decision engine 24 and the system 27 or other system 10. In the illustrative embodiment, the dashboard 23 enables 1) defining new or extra rules, 2) changing existing rules in order to hedge newly perceived or differently perceived risks to the value safety margin of value stock, or 3) changing loan granting rules or general rules or parameters and variables used. In addition to actively changing these system parameters, the dashboard interface also allows for the analysis of performance and general functioning of the system in automated and non-automated modes.

The dashboard 27 comprises a first or right brain user interface display 80, used predominantly for viewing of video content which, in the illustrative embodiment, may be implemented with television display and an accompanying remote controls. A second or left brain user interface in system 27 predominantly uses and/or stimulates activity in the left hemisphere of the human brain, and also, to a limited extent, the right hemisphere of the human brain. System 27 may be implemented with a traditional personal computer, including a desktop or laptop system, as well as other systems. In an exemplary embodiment, dashboard 33 presents visual, non-textual information while computer 27 displays textual and/or numeric information and graphics.

Semi-Automatic Trading System with Left Brain Interface

In order to minimize the level of Desire and the associated Right Brain Consciousness activity, the trading system used by the Central Value Bank should be semi-automated and Objectively structured.

This automatic trading is based on a mathematical and thus Objective software model that models the Margin of Safety between the current trading price and the current intrinsic Value of the traded asset (e.g. share). In a first embodiment the model incorporates an optimization function for the Margin of Safety between the current price and the Value of a security, calculated by dividing the price through the total percentual weighted historic earnings and/or paid out dividends and/or other Value indicators. By minimizing this function with boundary conditions consisting of balance sheet risks and other risks such as geopolitical risks, monetary inflation risks, perceptual and absolute exposure risk and other risks, the best buys are selected. A risk is defined as an Objectively defined Fear for loss; it cannot Subjectively be defined as a loss of opportunity. At times the trading system cannot fully automatically function, manual intervention is allowed, but Subjective judgment should be minimized.

Non-exceptional manual intervention is done through a Left Brain software interface. Such left brain software interface is designed to limit the available Actions only to Actions that are related to objectively modeled Fears or risks. For example a manual trade or new automatic trading rule in order to optimize return is not allowed and therefore blocked in the interface.

Dashboard with Right Brain Interface

During exceptional periods, entering a new boundary condition that models a new or altered risk is allowed and well supported in the interface. Exceptional periods are periods during which new Objective risks are detected in the environment, not periods during which new Subjective opportunities are experienced.

All processes dealing with minimizing known risks may under the Value Banking System be maximally automated in software and, regardless of software automation, should be maximally Left Brain.

However, detecting unknown threats and devising hedging strategies is an activity of the Right Brain Consciousness. The Right Brain processes are interfaced through a dashboard, as illustrated in FIG. 2, which functions as, an interface between Central Value Bank management decision engine and the participating bank system. In the illustrative embodiment, the dashboard enables 1) analyze phenomena graphically, 2) defining new or extra rules and running simulations on past data, 3) changing existing rules in order to hedge newly perceived or differently perceived risks to the Value safety margin of Value stock and run simulations, or 4) changing loan granting rules or general rules or parameters and variables used and run simulations.

In addition to actively changing the system parameters, the dashboard interface also allows for simulation of newly proposed hedging strategies and graphical analysis/synthesis of performance and general functioning of the system in automated and non-automated modes.

Semi-Automatic Trading System with Left Brain Interface

In order to minimize the level of desire and the associated right brain consciousness activity, the trading necessary for deposit taking and associated value investment and for deposit pay out and associated value disinvestment should be maximally automated.

This automatic trading is based on a mathematical software model that models the margin of safety between the current trading price and the value of the stock or bond. Such model incorporates an optimization function for the margin of safety between the price and the value of a security weighing and totaling historic and/or predicted earnings and/or dividends paid out and/or other value indicators as well as boundary conditions consisting of balance sheet risks and other risks such as geopolitical risks, monetary inflation risks, perceptual and absolute exposure risk and other risks. Risk is defined as an objectively defined fear for loss, not subjectively defined and not as a loss of opportunity, if such trading system cannot be executed fully automatically, manual intervention may be exceptionally allowed.

Non-exceptional manual intervention may be done through a left brain software interface. Such left brain software interface may be designed to limit the available actions to actions that are related to objectively modeled fears or risks. For example, a manual trade or new automatic trading rule in order to optimize return is not allowed and therefore blocked in the interface, however entering a new boundary condition that models a new or altered risk is allowed and well supported in the interface.

Management Cost

The operational cost of the Central Value Bank cannot exceed a previously determined and transparently communicated percentage of the outstanding bank's money and savings bonds.

Transparency

The Central Value Bank's standards and rules, including choices of variables (such as the numerical Value of mentioned percentages') are transparently communicated to the public and rigorously applied and enforced. The Central Value Bank's bylaws reflect this disclosure's rules. Management is liable in case of willful breach. Bylaws can be changed to a those of a Central non-Value Bank, when the majority of votes of savings bonds holders desires so, but only if the Central Value Bank pays out the no voters who wish so.

Software Implementation of a Safety Margin Algorithm

FIG. 8 illustrates the algorithmic process 800 for developing a Value Stock portfolio utilizing one or more of the computer systems and software described herein. Specifically, the process for creating an equity portfolio by computing for each equity instrument i) an objective fundamental criteria, and ii) a subjective market criteria, as illustrated by process blocks 802 and 803. In the illustrative embodiment, the Objective fundamental criteria may comprise any number of criteria such as valuation multiples, profitability criteria, solvency criteria and liquidity criteria with regard to the most recent fiscal year available. Similarly, Subjective market criteria, may comprise criteria such as market capitalization and average daily turnover. In the illustrative embodiment, network accessible memory 30 and 20 of system 10 is utilized to store data on a plurality of equity instruments, each equity instrument associated with an entity issuing the equity instrument, for example, a sovereignty, government agency, corporation. The nature type of the equity instrument may be chosen from a large plurality of different equity instrument types.

In one embodiment, the underlying equity instrument comprising the asset that substantiates the currency comprises at least one of: a stock; a commodity; a futures contract; a bond; a mutual fund; a hedge fund; a fund of funds; an exchange traded fund (ETF); a derivative; and/or a negative weighting on any asset. Such equity instruments may also comprise any of a debt instrument; at least one unit of interest in at least one of; an asset; a liability; a tracking portfolio; a financial instrument and/or a security, where the financial instrument and/or the security denotes a debt, an equity interest, and/or a hybrid; a derivatives contract, including at least one of: a future, a forward, a put, a call, an option, a swap, and/or any other transaction relating to a fluctuation of an underlying asset, notwithstanding the prevailing value of the contract, and notwithstanding whether such contract, for purposes of accounting, is considered an asset or liability; a fund; and/or an investment entity or account of any kind, including an interest in, or rights relating to: a hedge fund, an exchange traded fund (ETF), a fund of funds, a mutual fund, a closed end fund, an investment vehicle, and/or any other pooled and/or separately managed investments.

In another embodiment, an objective metric of intrinsic value of an equity instrument, which serves as the underlying asset substantiating the currency, may comprise at least one of: revenue; profitability; sales; total sales; foreign sales, domestic sales; net sales; gross sales; profit margin; operating margin; retained earnings; earnings per share; book value; book value adjusted for inflation; book value adjusted for replacement cost; book value adjusted for liquidation value; dividends; assets; tangible assets; intangible assets; fixed assets; property; plant; equipment; goodwill; replacement value of assets; liquidation value of assets; liabilities; long term liabilities; short term liabilities; net worth; research and development expense; accounts receivable; earnings before interest and tax (EBIT); earnings before interest, taxes, dividends, and amortization (EBITDA); accounts payable; cost of goods sold (CGS); debt ratio; budget; capital budget; cash budget; direct labor budget; factory overhead budget; operating budget; sales budget; inventory system; type of stock offered; liquidity; book income; tax income; capitalization of earnings; capitalization of goodwill; capitalization of interest; capitalization of revenue; capital spending; cash; compensation; employee turnover; overhead costs; credit rating; growth rate; tax rate; liquidation value of entity; capitalization of cash; capitalization of earnings; capitalization of revenue; cash flow; and/or future value of expected cash flow.

In another embodiment, the universe of entities with which an equity instrument may be associated may include at least one of: a sector; a market; a market sector; an industry sector; a geographic sector; an international sector; a sub-industry sector; a government issue; and/or a tax exempt financial object; agriculture, forestry, fishing and/or hunting industry sector; mining industry sector; utilities industry sector; construction industry sector; manufacturing industry sector; wholesale trade industry sector; retail trade industry sector; transportation and/or warehousing industry sector; information industry sector; finance and/or insurance industry sector; real estate and/or rental and/or leasing industry sector; professional, scientific, and/or technical services industry sector; management of companies and/or enterprises industry sector; administrative and/or support and/or waste management and/or remediation services industry sector; education services industry sector; health care and/or social assistance industry sector; arts, entertainment, and/or recreation industry sector; accommodation and/or food services industry sector; other services (except public administration) industry sector; and/or public administration industry sector.

In other embodiments, the underlying asset base substantiating an amount of currency comprises equity instruments other than debt instruments of a government or sovereignty.

Next, any equity instrument having an associated value for the objective fundamental criteria and the subjective market criteria outside a predefined range of values, e.g., outliers, is eliminated from the equity instrument data set, as illustrated by process block 804. Thereafter, a risk minimization processes is utilized which, in one embodiment, may comprise, for each of the plurality of equity instruments, scaling a ratio of the computed value of the objective fundamental criteria to the computed value of the subjective market criteria of the equity instruments by at least one weighting criteria so as to minimize risk, as illustrated by process block 806. In another embodiment, the risk may be minimized utilizing a linear equation having the form:

min[valuation multiple i*portfolio weights]

which is solved for each of the plurality of equity instruments, using the value for the objective fundamental criteria and the subjective market associated with the equity instrument and at least one predefined weighting criteria, as also illustrated by process block 806. The predefined weighting criteria may be stored in memory 20 of system 10 as one or more rules 21 interoperable with decision engine 24. Such rules may, for example, have the form of any of the following:
Rule 1—No more than x % (of the total value of the equity portfolio) shall be invested in one
Rule 2—No more than y₁% could be invested in one country;
Rule 3—No less than y₂% could be invested in one currency region;
Rule 4—The portfolio's profitability criteria must be in the upper α^{th} percentile;
Rule 5—The portfolio's solvency criteria must be in the upper β^{th} percentile;
Rule 6—The portfolio's liquidity criteria must be in the upper γ^{th} percentile;
Rule 7—The portfolio's valuation multiples (except for valuation multiple i) must be in the lower zth percentile.

In one embodiment, in Rule 1 the value of x may be between 0%-5% but more preferably between 0%-2%, but even more preferably between less than 1%. In additional the value of x may be pre-determined or calculated dynamical y by a separate risk model.

In one embodiment, in Rule 2 and Rule 3, y1 and y2, respectively, may have vales depending on matching the ratio of foreign trade currencies in the foreign trade of the community using the currency, with the ratio of selected stock expressed in those foreign currencies.

In one embodiment, in Rules 4, 5 and 6, alpha, beta and gamma, respectively, are typical higher best quarter selections, and may have values between 1%-100%, but more preferably between 50%-100% but even more preferably between 75% and 100%.

In one embodiment, in Rule 7, z may have a value representing a lower best quarter selection, and may have values between 0%-100%, but more preferably between 0%-50% but even more preferably between 0% and 25%.

Thereafter, only those equity instruments resulting in positive weight values in step 808 are retained within the equity portfolio, as illustrated by process block 810. The exemplary embodiments of the above-described Safety Margin algorithm described herein is for illustrative purposes and are not meant to be limiting.

### Targeted Objective Complementary Currency

Value Money, that is money that is substantiated by, backed by or that represents value equity stock as described herein, is referred to herein as Blue Money. Blue Money has objective, intrinsic and stable economic value similar to currency 5 described herein. To protect complementary currencies 15 described herein from losing value, because of monetary effects such as inflation in the dominant fiat currency or because of an ineffective structural set-up, these complementary currencies 15 are coupled to value currency 5, hereby being value secured and trustworthy for saving purposes. The structure of such coupling and effective set-up and the practical implementation is described herein. Complementary currency 5 that securely stores and therefore supports economic value is referred to herein as Value Money or Blue Money. Complementary currency 15 that supports social value and is coupled with Blue Money as well as properly set-up is referred to herein as Red Money. Complementary currency 15 that supports an environmental or religious or non-secular objective value and is coupled with Blue Money as well as properly set-up is referred to herein as Green Money.

By implementing and using money in three dimensions: economic (blue), social (red) and environmental or nonsecular (green), people are able to save their created value, while contributing to a targeted objective, their moral value of choice Spending tax money on these values can therefore be reduced, while private spending takes over, freeing up government budgets to reduce debt and solve financial and sovereign debt crises.

Blue Money

Value money is fair and effective money that stores value safely over time, making it suited for saving because it represents objective value, and, therefore, also becomes fair, since it serves as an objectively valid means of exchange between different subjects or people.

Blue Money or Value Money stores value securely over time, because it is a certificate that represents public value stock, guaranteeing its long term value, as illustrated conceptually by the graphic in FIG. 6A and balance sheet of FIG. 6A. In an illustrative embodiment, when other currencies enter the balance sheet, they are invested in public value stock, based on value investment criteria and new money is created as a certificate sharing in the ownership of the assets as represented in the upper left box 40 of FIG. 6A, while Blue Money issued by the Central Value Bank is represented the upper right box 42 of FIG. 6A. In the illustrative embodiment, when bans are granted they are financed through Blue Saving Bonds. Loan takers may hold a predetermined threshold, e.g. x %, of their outstanding loan as perpetual Blue Bonds, which are invested in private value equity,

Red Money

The color of value money supporting economic value as previously discussed is blue money. Red money is equally value secured as blue money, since it is at all times exchangeable for blue money, by spending or exchanging it. Red money includes, however, an extra subjective, moral value in addition to blue money's gratitude: i.e. the social value. Red money allocates the financial proceeds of blue money to social goals, as chosen by the holder of the red money.

Social projects are approved by the Central Value Bank's governing body, based on objective criteria only. Social goals may be social, but it is not up to the governing body to favor certain content, only to guard the form. Financial proceeds of blue money, i.e. the arbitrage proceeds as well as the interests on red saving bonds, are allocated to the approved social projects, pro rata by the votes of money and bond holders, for the bond's life or as long as the money or perpetual bond is held by the voter.

Red saving bonds are acquired at issuance as blue saving bonds on which subsequently a social goal preference is set by the owner/holder, and are tradable on the market at a discount eventually indirectly determined by the specific social goal.

In the illustrative embodiment, Red Money is a currency certificate 15C that represents Blue Money, e.g. value currency 5, and can at any given time be exchanged for Blue Money at a 1 to 1 rate. This can be done over a website for electronic money or over changing a setting on chip 4 on currency 15B-C or by other currency exchange mechanisms. Also, the specific social goal to be supported with the financial return of that money can be set in the same way. A personal electronic signature can automatically change Blue Money into Red Money, including allocating the financial proceeds of that money towards a specific social goal, for the time it is property of that person. The percent distribution of the financial proceeds between the different types of social goals or caregiving is personal and can automatically be net in accordance with a stored ratio associated with the electronic signature. Social goals can include, but are not limited to socially conscious targeted objectives such as: care for elderly, child care, care for specific illnesses, general disease caring, homeless caring, education, etc. Only organizations approved by the Central Value Bank receive such proceeds, periodically, in return for service level agreements towards this social goals or care recipients.

When people convert Blue Money into Red Money it enters the balance sheet, as Blue Money represented in the left upper corner left box 44 of FIG. 6B and as Red Money represented in the right upper corner 46 of FIG. 6B. When people buy Red Savings bonds, represented in the right bottom corner 48 of FIG. 68, the proceeds are used to buy Blue Savings Bonds at the same maturity represented in the left bottom corner 50 of FIG. 68.

The financial proceeds of Red Money consist of the share in the arbitrage proceeds collected by the Central Value Bank on arbitraging the exchange rate of Blue Money against other currencies. The financial proceeds of the Red Saving Bonds are the interests received on the Blue Saving Bonds they represent. The proceeds allocation Red Savings Bonds is valid until its maturity date, allowing care givers to work long term. In the illustrative embodiment, only objective criteria play a role in allocating proceeds within a category to a certain profit or non-profit organization.

Green Money

Green Money is a certificate that represents Blue Money and can at any given time be exchanged for Blue Money at a 1 to 1 rate. Such exchange can be done over a website for electronic money or over changing a setting on the chip 4 on currency 158-C or by other currency exchange mechanisms. Also the specific religious or environmental goal to be supported with the financial return of green money can be set in the same way. A personal electronic signature can automatically change Blue Money into Green Money, including allocating the financial proceeds of that money towards a specific religious or environmental goals, for the time it is property of that person. The percent distribution of the financial proceeds between the different types of environmental assets or non-secular causes is personal and can automatically be set in accordance with a stored ratio associated with the electronic signature. The percent distribution of the financial proceeds between the different types of green objectives is personal and can automatically be set by the signature.

Similar rules apply to green money as with red money, except the proceeds of money as well as the bond's capital are invested in personally preferred green durable assets. Green goals are not expenses but green asset purchases including, but not limited to: buying rain forest, buying ocean, buying fishing quota, buying CO2 certificates, buying or building churches, etc. Only organizations approved by the Central Value Bank will propose or broker green asset investment cases.

When people convert Blue Money into Green Money it enters the balance sheet, as Blue Money represented in the left upper corner 52 of FIG. 6C and as Green Money represented in the right upper corner 54. When people buy Green Savings bonds represented in the right bottom corner 56 of FIG. 6C, the proceeds are used to buy Green assets, e.g. environmental assets, represented in the left bottom corner 58 of FIG. 6C, with the same time horizon. When Green Saving Bonds mature and new Green Saving Bonds at the same maturity are not sufficiently placed in the market. Green assets may be sold to redeem the matured Green Saving Bonds. The financial proceeds of Green Money consist of the share in the arbitrage proceeds collected by the Central Value Bank on arbitraging the exchange rate of Blue Money against other currencies. Only objective criteria play a role in allocating proceeds within a category to a certain profit or non-profit organization that brokers the purchase of Green Assets. If these assets need to be sold, when more green bonds become due than can be replaced, owners of green bonds may lose value pro rata on their preferred green assets.

The governing body organizing the Central Value Bank is also the governing body organizing the Green and Red Money. The balance sheets of Blue, Red and Green Money are separated, they may be managed by the same or different management organizations. Management cost may be limited to a certain percentage of funds managed, for all three colors of Money.

FIG. 9 illustrates the algorithmic process 900 for redeeming a targeted objective complementary currency utilizing one or more of the computer systems and software described herein. Specifically, the process for creating an equity portfolio by computing for each equity instrument i) an objective fundamental criteria, and ii) a subjective market criteria, is described with reference to FIG. 8. In the illustrative embodiment, network accessible memory 30 and 20 of system 10 is utilized to store data on a plurality of equity instruments, each equity instrument associated with an entity issuing the equity instrument, for example a sovereignty, government agency, corporation. The nature and type of the equity instrument may be chosen from a large plurality of different equity instrument types, as described herein, as indicated by process block 902.

In the illustrative embodiment, a targeted objective complementary currency may take the form of saving bonds, e.g., red or green, acquired at issuance as a value currency, e.g. blue saving bonds, but on which subsequently a social goal preference is set by the owner/holder, and are tradable on the market at a discount eventually indirectly determined by the specific social goal. The social goal preference associated with the targeted objective documentary currency is defined at the time of acquisition, as indicated by process block 904. At such time, a data structure 100, as illustrated in FIG. 10, is defined with relevant data relating to the nature of the objective.

Specifically, data structure 100 comprises an instrument identification field 102, and instrument type definition field 104, and owner identification field 106, a personal electronic signature field 108, and recipient field 110 which defines the recipient or cause to which the proceeds of the instrument will be directed in accordance with the percentage of the instrument value as defined in the corresponding respective percentage field 112. Note that the data structure may have multiple recipients 110A, 110B . . . 110N, each with their own corresponding percentage field 112A, 112B . . . 112N, respectively. Once defined, data structure 100 for a particular instrument will be stored in memory, at one or both of the Central Bank as well as any participating banks within the system.

The targeted objective complementary currency may be represented by any of complementary currency forms 5A-C and can at any given time be exchanged for a value currency at a 1 to 1 rate. Such exchange can be done over a website for electronic money or over changing a setting on chip 4 on currency 15B-C or by other currency exchange mechanisms. Also, the specific social goal to be supported with the financial return of that currency can be set in the same way. A personal electronic signature, as stored in field 108 of data structure 100 can be used to automatically change Blue Money into Red Money, including allocating the financial proceeds of that money towards a specific social goal, for the time it is property of that person or entity.

If the owner of an instrument representing targeted objective complementary currency wishes to sell, as illustrated in decision block 906, their personal electronic signature may be submitted electronically and compared with the value of data field 108, as illustrated by process block 908. Thereafter, the value of the targeted objective complementary currency is redeemed or exchanged, as illustrated by procedure block 910. Next, the values of fields 110 and 112 are retrieved from memory, as illustrated by process block 912, and the value resulting from the redeeming of the value currency is multiplied by the percentage or scaling factors stored within the corresponding field 112 to determine how much of the resulting value is directed to the recipient or cause identified by the corresponding field 110, as illustrated by block 914. The providing of the respective value amounts to the designated recipient or cause may occur by any conventional means including wire transfer, physical currency, electronic currency, etc.

Although the various embodiments of the system and techniques disclosed herein have been described with reference to equity instruments in the form of stock, the system described herein, particularly the portfolio models may be equally utilized with other types of equity instruments with substantially the same disclosed system and techniques as would be understood by those reasonably skilled in the relevant arts, given the disclosures as set forth herein. As such, the exemplary embodiments described herein are for illustrative purposes and are not meant to be limiting. It will be obvious to those reasonably skilled in the art that modifications to the systems and processes disclosed herein may occur, without departing from the true spirit and scope of the disclosure.

What is claimed is:

1. An article of manufacture for use as currency comprising:
A) a token representation of an amount of value as an amount of complementary currency;
B) a mechanism integrated with the token representation for substantiating a value of the primary currency with an underlying asset having intrinsic value associated with the amount of complementary currency; and
C) a mechanism for identifying that a portion of the value of the complementary currency is designated for at least one of a predetermined recipient and cause.

2. The article of manufacture of claim 1 wherein the mechanism for substantiating comprises a smart chip associated with the currency.

3. The article of manufacture of claim 1 wherein the mechanism for substantiating comprises a resolvable computer address embedded in the token representation of the currency.

4. The article of manufacture of claim 1 wherein the mechanism for substantiating comprises an alert mechanism for indicating if the intrinsic value of the asset associated with the amount of currency has exceeded a predetermined threshold range of values.

5. The article of manufacture of claim 1 further comprising:
D) a mechanism for identifying the current holder of the token representation of the amount of currency.

6. The article of manufacture of claim 1 further comprising:
E) a mechanism for identifying a portion of income from the currency designated for the at least one of the predetermined recipient and cause.

7. A financial instrument comprising:
A) a token representation of a primary currency having a value amount substantiated and secured by an asset base haying intrinsic value and associated with the value amount of the primary currency;
B) a token representation of a complementary currency associated with the primary currency; and
wherein the complementary currency defines at least a portion of the value of the primary currency payable to at least one of a social, environmental or nonsecular recipient or cause, as defined by a holder of the financial instrument.

8. The method of claim 7 wherein the asset base comprises other currency instruments.

9. The method of claim 7 wherein the asset base comprises a combination of equity instruments and other currency instruments.

10. The method of claim 7 wherein the asset base comprises a equity instruments other than debt instruments of a government or sovereignty.

11. A method of preventing fluctuations in the value of a tangible currency or an intangible token of such tangible currency or an intangible currency, the method comprising:
A) providing an amount of a tangible currency or of an intangible token of such tangible currency or of an intangible currency, as a tangible or intangible token representing an amount of value, the amount of currency having a numerical nominative value;
B) substantiating the intrinsic value of the amount of currency with a portfolio of equity instruments by making the amount of currency a certificate representing ownership or profit rights in the portfolio of equity instruments; and
C) directing at least a portion of the value of the currency payable to at least one of a social, environmental or nonsecular recipient or cause, as defined by a holder of the financial instrument.

12. The method of claim 11 wherein B) comprises:
B1) modeling an absolute or relative safety margin between the modeled intrinsic value of an equity instrument and a market price of the equity instrument, in order to select and/or reselect the equity instrument portfolio substantiating the amount of currency.

13. The method of claim 12 wherein B) further comprises:
B2) selecting equity instruments as part of the portfolio to hedge one of foreign exchange risks and risks of import of monetary instability from other currencies, for users of the amount of currency.

14. The method of claim 13 wherein B) further comprises:
B3) matching the ratio of foreign trade currencies in the foreign trade of the community using the currency, with the ratio of selected stock expressed in those foreign currencies.

15. The method of claim 11 wherein the amount of currency has the form of coins, paper or plastic currency, or electronic certificates.

16. The method of claim 11 wherein selection of equity instruments in the portfolio of equity instruments is based on at least one predetermined rule for hedging long term risk.

17. The method of claim 11 wherein arbitrating price against intrinsic value of the equity instrument is performed in accordance with at least one predetermined rule for hedging short term risk.

18. The method of claim 11 wherein the tangible or intangible currency or its electronic token has a verification mechanism associated with representation of the amount of currency for enabling confirmation or verification of the intrinsic value associated with the amount of the currency.

19. The method of claim 18 wherein the value verification mechanism comprises a resolvable computer address embedded in a representation of the currency.

20. The method of claim 18 wherein the value verification mechanism comprises an alert mechanism for indicating if the instantaneous intrinsic value of the amount of currency has exceeded a predetermined maximal threshold or subceeded a predetermined minimal thresholds.

21. A computerized banking system comprising:
A) at least one network accessible central bank system comprising:
i) a network interface;
ii) at least one processor;
iii) a memory for storing an executable equity portfolio model and a plurality of predefined rules associated with selection or trading of equity instruments and the issuance of currency, the currency;
B) at least one certificate, the certificate representing ownership or profit rights in the portfolio of equity instruments and having associated therewith an amount of value currency substantiated by intrinsic value of a portion of the portfolio of equity instruments; and
C) a data structure associated with each certificate and stored in memory, the data structure comprising:
i) data identifying the certificate;
ii) data identifying an owner of the certificate;
iii) data identifying at least one of a social, environmental or non-secular recipient or cause;
iv) data identifying a percentage of the value currency of the certificate to which the identified social, environmental or non-secular recipient or cause is entitled.

22. The system of claim 21 further comprising:
D) a plurality of participating bank systems coupled over a network to the central bank system, each of the participating bank systems comprising a user interface for enabling automated and semi-automated interaction with the central bank system over a network.
